(19) United States
(12) Patent Application Publication
(10) Pub. No.: US 2024/0283096 A1
(43) Pub. Date: Aug. 22, 2024

(54) NOVEL CYLINDRICAL CELL ARRANGEMENTS FOR BATTERY PACKS TO REDUCE THE EFFECTIVE MAGNETIC FIELD

(71) Applicant: IDEAFORGE TECHNOLOGY PVT. LTD., Navi Mumbai (IN)

(72) Inventors: Amit GUPTA, Navi Mumbai (IN); Himanshu AGRAWAL, Navi Mumbai (IN)

(21) Appl. No.: 18/291,120

(22) PCT Filed: Jun. 14, 2022
(86) PCT No.: PCT/IB2022/055492

§ 371 Date: Jan. 22, 2024

(30) Foreign Application Priority Data
Jul. 22, 2021 (IN) 202121033012

(51) Int. Cl. H01M 50/509; H01M 10/0525; H01M 50/213; H01M 50/249

(52) U.S. Cl. CPC H01M 50/509; H01M 10/0525; H01M 50/213; H01M 50/249; H01M 2220/20

(57) ABSTRACT

An improved battery pack 100/200 is disclosed, having a plurality of cylindrical cells 102 arranged in parallel disposition in rows 104/204 and columns 106/206 such that positive and negative terminals of any of the cells and the closest surrounding cells are oppositely placed to minimise the overall magnetic field due to the internal current of the cells by the opposite magnetic field of the oppositely placed adjacent cells. The positive and negative terminals at any of or both of upper and lower ends of the cells 102 in a group of adjacently located columns are connected by criss-cross connections 108/208 to provide parallel electric connection of the cells 102 in groups of adjacently located columns 106/206. Criss-cross connections 108/208 pertaining to the terminals of opposite polarity are connected by series connections 110/210 to provide series connection of the sets of cells connected in parallel by the criss-cross connections 108/208.

### TECHNICAL FIELD

The present disclosure relates to the field of battery packs. In particular, the present disclosure relates to battery packs for drones/UAVs. More particularly, it pertains to battery arrangement to overcome the problem of high magnetic fields, which affects the magnetometer of auto-pilot of the drone/UAV.

### BACKGROUND

Background description includes information that may be useful in understanding the present invention. It is not an admission that any of the information provided herein is prior art or relevant to the presently claimed invention, or that any publication specifically or implicitly referenced is prior art.

Use of Lithium-Ion batteries is well known in the art. They are beneficial as they have a higher energy density, specific power and lower self-discharge rate than most other rechargeable batteries. This makes for better energy efficiency as a single cell has longer charge retention than other battery types. Cylindrical Li-ion cells are widely used, however, due their cylindrical shape while connecting they have a problem of high magnetic fields, which eventually affects the magnetometer of the auto-pilot of the drone/UAV.

A Lithium-Ion battery typically includes a plurality of cylindrical lithium-ion cells that are electrically connected in series or parallel. or a combination of series and parallel connections to provide a desired voltage and current. The cells are arranged parallel to each other and carry an internal current between its positive and negative terminals. According to Biot-Savart Law, every current carrying conductor produces magnetic field around it. The magnetic field intensity is high near the current carrying medium and reduces with distance as square of the distance. Based on this law, the different cells of a battery carrying internal current produce magnetic field around the cells. In the typical series and parallel combination, overall magnetic field around the battery pack collectively becomes high.

The effective magnetic field in a large battery pack, where number of cells in a traditional series and parallel combinations, is higher. That larger magnetic field may largely affect the nearby magnetic devices, which may result in a malfunction of the magnetic device.

Typically, the cylindrical cells are arranged in plurality of rows, wherein each cell in a single row have their positive and negative poles in the same direction but are opposite in direction with the positive and negative poles of the cells in the adjacent rows. The positive and negative poles of the cells in different rows are connected with a plurality of series-parallel conductive nickel strap connections. Even though the magnetic fields produced by the adjacent rows oppose each other, a higher distance between them results in only a little amount of the magnetic field getting cancelled

Therefore, there is a requirement of an improved battery arrangement that reduces the effective magnetic effect of the battery pack.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

A general object of the present disclosure is to overcome drawbacks of the conventional batteries, such as Li-Ion batteries.

An object of the present disclosure is to provide a battery pack that has reduced magnetic field due to current in the cells.

Another object of the present disclosure is to provide a battery pack with reduced magnetic field that is of reduced size when compared to a conventional battery of the corresponding capacity.

Another object of the present disclosure is to provide a battery pack with increased energy density (Wh/kg), thereby a higher endurance.

Another object of the present disclosure is to provide a battery pack with reduced magnetic field that can be configured for different desired outputs.

### SUMMARY

Aspects of the present disclosure relate to an improved arrangement of cylindrical cells in a battery pack. In particular, it provides a battery pack with reduced magnetic field around it, thus having a minimal adverse effect on functioning of a magnetometer of auto-pilot of a drone/UAV, or any other similar application, where the battery pack is used.

In an aspect, the proposed improved battery arrangement (hereinafter also referred to simply as battery) is based on a plurality of cylindrical cells that are arranged such that magnetic field generated due to internal current in the cells is mutually cancelled. In an aspect, the cylindrical cells are arranged in parallel disposition such that positive and negative terminals of any of the cells and the closest surrounding cells are oppositely placed so that the magnetic field generated by the cell is cancelled by the opposing magnetic field generated by the surrounding cells,

The plurality of cells can be arranged in a plurality of parallelly arranged rows and columns with adjacent cells in each of the rows and the columns having respective positive and negative terminals in opposite directions. Further, the plurality of rows and columns are arranged such that the closest surrounding cells or orthogonally placed cells of any of the cells are oppositely placed cells.

In different embodiments the battery pack can have different number of cells arranged in various combinations of rows and columns providing various series and parallel configurations. In particular, the disclosed methodology of arranging the cells and the connecting them in parallel and series can be applied on any 2-dimensional battery pack with ‘n’ number of rows and columns, where n=2 or more. In an embodiment, the columns of the plurality of cells can be divided in groups of adjacently located columns, wherein each group of adjacently located columns includes two or more columns. Each of the positive terminals and the negative terminals at any of or both of upper ends and lower ends of the cells in the group of adjacently located columns can be connected in a criss-cross manner by one or more conductors. The mutually connected positive terminals and the negative terminals at any or both ends of the cells in one group of adjacently located columns provides two sets of parallelly connected cells. Multiple groups of adjacently located columns results in more than two sets, of parallelly connected cells, which can be further connected in series.

In an embodiment, the mutually connected positive terminals at the upper end of the cells of one the groups of adjacently located columns can be connected to a main positive terminal of the battery pack, and the mutually connected negative terminals at the upper end of the cells of another of the group of adjacently located columns of the battery pack can be connected to a main negative terminal of the battery pack.

In an embodiment, the remaining mutually connected positive terminals and the mutually connected negative terminals at any or both of upper ends and lower ends of the cells of the sets of parallelly connected cells of the different groups of adjacently located columns can be connected to the mutually connected terminals of opposite polarity at the respective ends of the cells of the adjacent group of adjacently located columns to provide a series connection of the sets of parallelly connected cells of the different groups of adjacently located columns.

In an alternate embodiment, the connection of the positive terminals and the negative terminals in criss-cross manner in the groups of adjacently located columns along with the connection between the mutually connected terminals of opposite polarities may be done only at the upper end of the cells, and the positive terminals and the negative terminals at the lower ends of all the cells may be connected to each other by shorting to provide a parallel connection of the cells in the sets of cells of the different groups of adjacently located columns, as well as series connection of the sets of parallelly connected cells.

In an embodiment, the connection between the criss-cross connections of the different groups of adjacently located columns can be configured to cause flow of current through the criss-cross connections such that magnetic effect of the current through all the criss-cross connections is minimized.

In an embodiment, appropriate insulation may be provided between the zig-zag conductors at crossing of the two zig-zag conductors to avoid short-circuit between the two zig-zag conductors.

In an embodiment, the battery pack can have 24 cells arranged in four rows and six columns, and the groups of adjacently located columns can include two adjacent columns, thereby the six columns forming three groups of adjacently located columns. The arrangement can result in six series and four parallel configuration.

In an embodiment, battery pack can have 12 cells arranged in two rows and six columns, and further the groups of adjacently located columns can have two columns, thereby the six columns forming three groups of adjacently located columns. The arrangement can result in six series and two parallel configuration.

In an embodiment, the battery pack can have 36 cells arranged in four rows and nine columns, and further the groups of adjacently located columns can have three adjacent columns, thereby the nine columns forming three groups of three adjacent columns. The arrangement can result in six series and six parallel configuration.

In an embodiment, the battery pack can have 48 cells arranged in three rows and sixteen columns, and further the groups of adjacently located columns can have four adjacent columns, thereby the sixteen columns forming four groups of four adjacent columns. The arrangement can result in eight series and six parallel configuration.

In an embodiment of application, the cells can be li-ion cells, and the battery pack can be for use in an Un-manned Aerial Vehicle.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A illustrates an exemplary arrangement of connections at a top side of a plurality of cells arranged in rows and columns to provide a six series and four parallel battery pack configuration, in accordance with embodiments of the present disclosure.

FIG. 1B illustrates an exemplary arrangement of connections at lower ends of the plurality of cells of FIG. 1A, in accordance with embodiments of the present disclosure.

FIG. 1C illustrates an exemplary circuit diagram showing connections between positive and negative terminals of the plurality of cells of FIGS. 1A and 1B, in accordance with embodiments of the present disclosure.

FIG. 2A illustrates an exemplary arrangement of connections at a top side of a plurality of cells arranged in in four rows and nine columns to provide a six series and six parallel battery pack configuration, in accordance with embodiments of the present disclosure.

FIG. 2B illustrates an exemplary arrangement of connections at lower ends of the plurality of cells of FIG. 2A, in accordance with embodiments of the present disclosure.

FIG. 3A illustrates another exemplary arrangement of connections at a top side of a plurality of cells arranged in three rows and twelve columns to provide a six series and six parallel battery pack configuration, in accordance with embodiments of the present disclosure.

FIG. 3B illustrates an exemplary arrangement of connections at lower ends of the plurality of cells of FIG. 3A, in accordance with embodiments of the present disclosure.

FIG. 4A illustrates another exemplary arrangement of connections at a top side of a plurality of cells arranged in two rows and six columns to provide a six series and two parallel battery pack configuration, in accordance with embodiments of the present disclosure.

FIG. 4B illustrates an exemplary arrangement of connections at lower ends of the plurality of cells of FIG. 4A, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms are used herein. To the extent a term used in a claim is not defined, it should be given the broadest definition persons in the pertinent art have given that term as reflected in printed publications and issued patents at the time of filing.

Embodiments explained herein relate to relate to an improved battery arrangement having a plurality of cylindrical cells that results in reduced magnetic field around the battery thus having a minimal adverse effect on functioning of a magnetometer of auto-pilot of a drone/UAV, where the battery pack is used.

It is to be appreciated that while the embodiments herein have been described with reference to lithium-ion battery packs, the concept of the present application can be applied to any other battery pack having a plurality of cylindrical cells of other types, such as but not limited to, Li—Po, Ni—CD, NMH cells etc., and all such applications are well within the scope of the present application without any limitations whatsoever.

The proposed improved battery pack is based on a novel arrangement of plurality of cylindrical cells that are arranged in parallel disposition in rows and columns such that magnetic field generated due to internal current in the cells is mutually cancelled. In an aspect, the rows and columns of the cells are arranged such that positive and negative terminals of any of the cells and the closest surrounding cells are oppositely placed so that the magnetic field generated by the cell is cancelled by the opposing magnetic field generated by the surrounding cells.

In different embodiments the battery pack can have different number of cells arranged in various combinations of rows and columns providing various series and parallel configurations to provide to battery packs of different voltage and current ratings. In particular, the disclosed arrangement can be applied to any battery packs having more than four cells, which can be arranged in two or more rows and two or more columns, the columns are grouped in groups of two or more adjacently located columns, and where the battery pack needs at least one series connection but at least 2 parallel connections.

In an exemplary implementation, the battery can have 24 cells arranged in four rows and six columns. The present disclosure provides an arrangement of connecting the cells to get a six series and four parallel configuration for the battery. In the disclosed arrangement, the columns of the cells can be divided in three groups of adjacently located columns (in different embodiments commonly referred to as group of adjacently located columns). The cells that have same orientation, i.e., respective positive and negative terminals in same direction, can be connected in parallel by connecting their positive terminals and the negative terminals in a criss-cross manner by one or more conductors (referred to as criss-cross conductors). Thus, each group of adjacently located columns results in two sets of four parallelly connected cells, and there being three groups of adjacently located columns, the criss-cross connection results in six sets of four parallelly connected cells. Further, the six sets of the parallelly connected cells can be connected in series by appropriately connecting the respective criss-cross conductors, while one each of the criss-cross conductors that are connected respectively to the positive and negative terminals of the corresponding cells can be connected to main positive terminal and main negative terminal of the battery.

In one embodiment, instead of connecting the positive and negative terminals on the upper ends and lower ends of the cells by one or more conductors, PCBs can be used to do the connection on any one or both of upper side and lower side of the battery pack.

In another exemplary implementation, the battery can have 36 cells arranged in four rows and nine columns. The present disclosure provides an arrangement of connecting the 36 cells to get a six series and six parallel configuration for the battery. In the disclosed arrangement, the columns of the cells can be divided in three sets of three adjacent columns (in different embodiments commonly referred to as group of adjacently located columns). The cells of each set of three adjacent columns that have same orientation, i.e. respective positive and negative terminals in same direction, can be connected in parallel by connecting their positive terminals and the negative terminals in a criss-cross manner by one or more conductors (referred to as criss-cross conductors). Thus, grouping in sets of three adjacently columns results in two sets of six parallelly connected cells, and there being three sets of three adjacently columns, the criss-cross connection results in six sets of six parallelly connected cells. Further, the six sets of the parallelly connected cells can be connected in series by appropriately connecting the respective criss-cross conductors, while one each of the criss-cross conductors that are connected respectively to the positive and negative terminals of the corresponding cells can be connected to main positive terminal and main negative terminal of the battery.

In yet another exemplary implementation, the battery can have 48 cells arranged in three rows and sixteen columns. The present disclosure provides an arrangement of connecting the 64 cells to get an eight series and six parallel configuration for the battery pack. In the disclosed arrangement, the columns of the cells can be divided in four groups of four adjacent columns. The cells of each set of four adjacent columns that have same orientation, i.e. respective positive and negative terminals in same direction, can be connected in parallel by connecting their positive terminals and the negative terminals in a criss-cross manner by one or more conductors (referred to as criss-cross conductors). Thus, grouping in sets of four adjacently columns results in two sets of six parallelly connected cells in each group, and there being four groups of columns, the criss-cross connection results in eight sets of six parallelly connected cells. Further, the six sets of the parallelly connected cells can be connected in series by appropriately connecting the respective criss-cross conductors, while one each of the criss-cross conductors that are connected respectively to the positive and negative terminals of the corresponding cells can be connected to main positive terminal and main negative terminal of the battery.

In still another exemplary implementation, the battery pack can have 12 cells arranged in two rows and six columns. The present disclosure provides an arrangement of connecting the 12 cells to get a six series and two parallel configuration for the battery pack. In the disclosed arrangement, the columns of the cells can be divided in four groups of two adjacent columns. The cells of each group of two adjacent columns that have same orientation, i.e. respective positive and negative terminals in same direction, can be connected in parallel by connecting their positive terminals and the negative terminals by criss-cross conductors. Thus, each group of two adjacently columns results in two sets of two parallelly connected cells, and there being four groups, the criss-cross connection results in eight sets of two parallelly connected cells. Further, the eight sets of the parallelly connected cells can be connected in series by appropriately connecting the respective criss-cross conductors, while one each of the criss-cross conductors that are connected respectively to the positive and negative terminals of the corresponding cells can be connected to main positive terminal and main negative terminal of the battery.

It is to be appreciated that while the embodiments of the present disclosure have been described with reference to 24 cells arranged and connected in 6s-4p configuration, 36 cells arranged and connected in 6s-6p configuration, 64 cells arranged and connected in 8s-6p configuration and 12 cells arranged and connected in 8s-2p configuration, it is possible to have different number of cells arranged and connected in other configurations as well and all such variations are well within the scope of the present disclosure without any limitations whatsoever.

In yet another embodiment, the connection between the criss-cross connections of the different parallelly connected cells can be configured to cause flow of current through the criss-cross connections such that magnetic effect of the current through all the criss-cross connections is minimized. It is to be appreciated that the parallel connection of the cells by criss-cross conductors may be limited to only the side which requires minimization of the magnetic field, such as top side, and the connection of the cells on other side, i.e., the lower ends of the cells can be done by other means such as shorting of positive terminals and negative terminals if the relevant cells, and all such variations are well within the scope of the present disclosure without any limitations whatsoever.

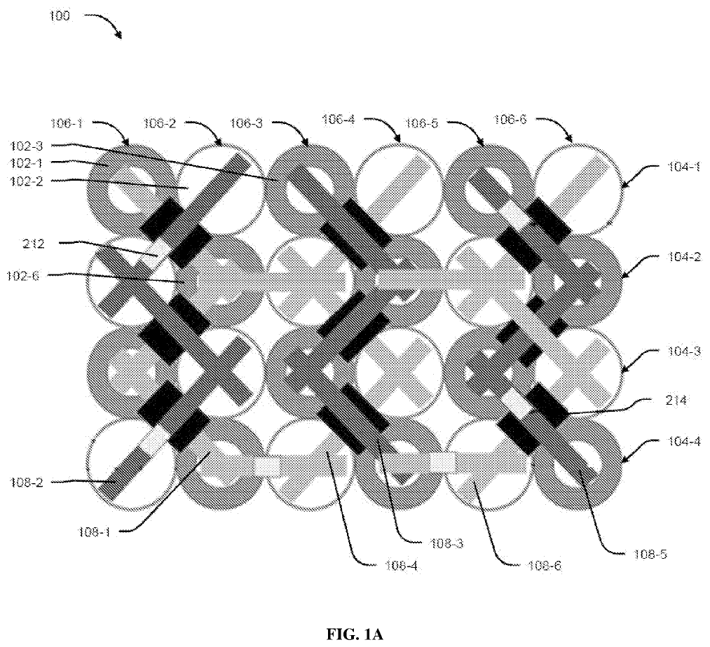

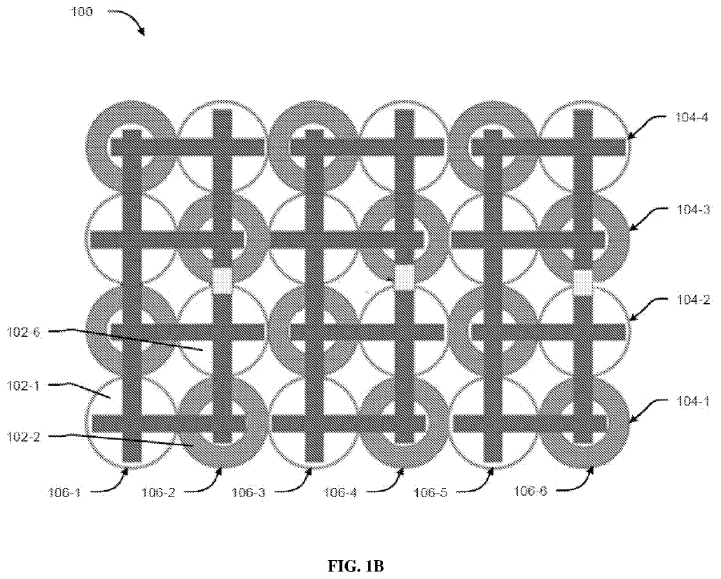

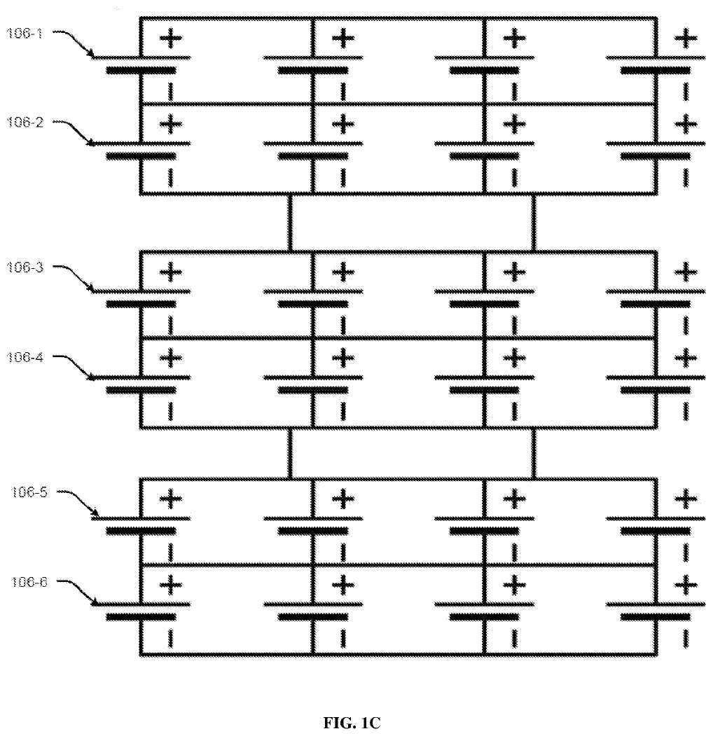

Referring now to FIGS. 1 to 1C, where a first embodiment of the disclosed battery pack (or simply battery) having 24 cells is disclosed, the battery 100 can include a plurality of cylindrical cells, such as cells 102-1. 102-2 . . . etc. (hereinafter collectively referred to as cells 102 and individually as cell 102) arranged in parallel disposition in rows, such as rows 104-1, 104-2 . . . etc. (hereinafter collectively referred to as rows 104 and individually as row 104), and columns, such as columns 106-1, 106-2 . . . etc. (hereinafter collectively referred to as columns 106 and individually as column 106). Adjacent cells 102 in each of the rows 104 and the columns 106 are having respective positive and negative terminals in opposite directions. The rows 104 and the columns 106 can be arranged such that the closest surrounding cells of any of the cells are oppositely placed cells, i.e. having positive and negative terminals in opposite directions.

For example, in the exemplary illustration of FIG. 1A, the cell 102-2 having its negative terminal at the top side of the battery 100 is positioned in the row 104-1 between the cells 102-1 and 1-2-3 whose positive terminal is at the top side of the battery 100, i.e., 102-1 and 102-3 are oppositely placed with reference to the cell 102-2. Likewise, the cell 102-6 positioned in the column 106-2 adjacent the cell 102-2 also has its positive terminal at the top side. Thus, the closest surrounding cells 102-1, 102-3 and 103-6 of the cell 102-2 are oppositely placed cells

As can be appreciated, internal current in the cell 102-2 shall be in direction opposite the direction of the internal current in the cells 102-1, 102-3 and 102-6. Further from Biot-Savart Law, it can be understood that due to direction of internal currents in the cell 102-2 being opposite of the direction of currents in the cells 102-1, 102-3 and 102-6, the magnetic field due to the current in the cell 102-2 shall be opposite of the direction of the magnetic fields due to the internal currents in the cells 102-1, 102-3 and 102-6 and shall get cancelled. Therefore, the arrangement causes the magnetic field generated by any of the cells 102 to be largely cancelled by the opposing magnetic field generated by the surrounding cells.

FIG. 1A further shows criss-cross connection that mutually connects the positive terminals and negative terminals of the cells 102 in groups of adjacently located columns. Specifically, in this embodiment the columns 106 are grouped in pairs of adjacent columns, i.e., each group of adjacently located columns includes two adjacent columns, such as a first group of adjacently located columns having columns 106-1 and 1-602, a second group of adjacently located columns having columns 106-3 and 106-4, and a third group of adjacently located columns having columns 106-5/106-6, to connect the cells in parallel. For example, criss-cross connection 108-1 mutually connects the negative terminals of cells in columns 106-1 and 106-2 that have their negative terminal on the top side of the battery, criss-cross connection 108-2 mutually connects positive terminals of cells in columns 106-1 and 106-2 that have their positive terminal on the top side of the battery, and likewise, the criss-cross connection 108-3 and 108-4 for the columns 106-3 and 106-4, and the criss-cross connection 108-4 and 108-6 (hereinafter collectively referred to as criss-cross connections 108 and individually as criss-cross connection 108) for the columns 106-5 and 106-6.

The criss-cross connections 108 can be provided by using one or more conductors, such as nickel straps. Similar criss-cross connections can be provided at lowerside of the battery 100 to complete the parallel configuration of the cells 102 in the groups of adjacently located columns. However, other types of connections, such as mutually shorting of positive and negative terminals of all the cells 102, one shown in FIG. 1B, are also within the scope of the present disclosure. As can be seen, each criss-cross connection 108 on the top side of the battery 100 along with similar criss-cross connections 108 or other types of connection on the lowerside of the battery 100, connects four cells 102 in parallel configurations. Different sets of parallelly connected four cells 102 can further be connected in series by suitably connecting the criss-cross connections 108, i.e., by connecting positive criss-cross connections 108 of one set of four parallelly connected cells to negative criss-cross connections 108 of other set of four parallelly connected cells. FIG. 1A shows such series connections, such as series connection 110-1 connecting the positive criss-cross connection 108-1, which connects positive terminals facing the top side of the cells 102 in column 106-1 and 106-2, to the negative criss-cross connection 108-4, which connects negative terminals facing the top side of the cells 102 in column 106-3 and 106-4, and similarly series connection 110-2 (herein after collectively referred to as series connection 110) connecting positive criss-cross connection 108-3, which connects positive terminals facing the top side of the cells 102 in column 106-3 and 106-4, to the negative criss-cross connection 108-6 that connects negative terminals facing the top side of the cells 102 in column 106-5 and 106-6. The series connections 110 can be located to result in flow of current through the criss-cross connections 108 such that magnetic effect of the current through all the criss-cross connections 108 is minimized.

When the criss-cross connections are used for inter connecting positive and negative terminals on the lower ends of the cells, similar series connections can be provided on the lowerside of the battery 100 also to complete the series connection of six sets of four cells each in parallel connection.

One of the positive criss-cross connection 108-5 on the top side of the battery can be connected to a main positive terminal 112 of the battery 100, and similarly one of the negative criss-cross connection 108-2 can be connected to a main negative terminal 114 of the battery 100, as shown in FIG. 1A. This completes 6 series-4 parallel (also referred to as 6s-4p) configuration of the 24 cells in the battery 100.

FIG. 1C shows a circuit diagram of connections between positive and negative terminals of the plurality of cells 102 resulting from the connections of positive and negative terminals on the upper side and the lower side of the cells 102, as shown in FIGS. 1A and 1B. As is evident, the cells 102 are connected in a six series and four parallel battery pack configuration.

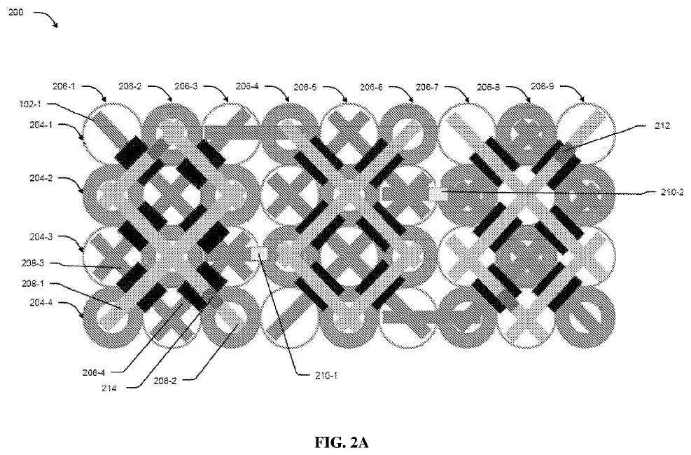

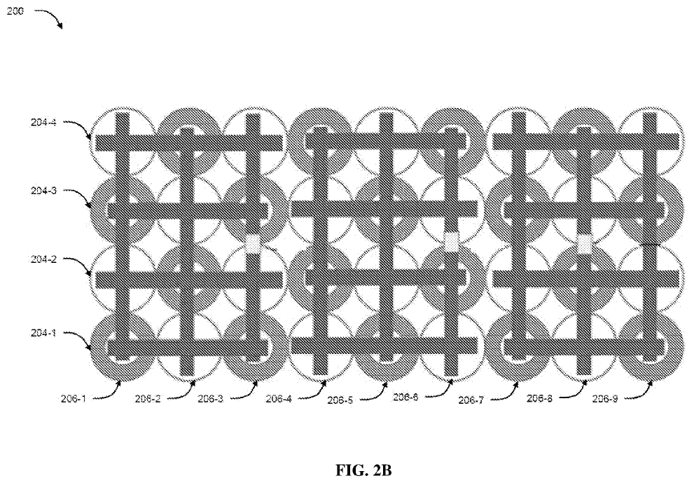

FIGS. 2A and 2B show the second embodiment of the present disclosure wherein 36 cells 102 of the battery 200 are arranged in four rows, such as rows 204-1, 204-2 . . . etc. (hereinafter collectively referred to as row/rows 206), and nine columns 206, such as columns 206-1, 206-2 . . . etc. (hereinafter collectively referred to as column/columns 206), are connected in 6 series-6 parallel (also referred to as 6s-6p) configuration using the same concept as enumerated above, with the difference that the groups of adjacently located columns comprise sets of three adjacent columns, such as columns 206-1, 206-2 and 206-3 in the first group, columns 206-4, 206-5 and 206-6 in the first group and columns 206-7, 206-8 and 206-9 in the first group.

FIG. 2A shows criss-cross connections that mutually connect top side positive terminals and negative terminals of the cells 102 in groups of adjacently located columns (group of three adjacent columns). As shown, each group of adjacently located columns includes two criss-cross connections, such as criss-cross connections 208-1 and 208-2, to mutually connect the positive terminals of the cells 102 in each group, and another two criss-cross connections, such as criss-cross connections 208-3 and 208-4, to mutually connect the negative terminals of the cells 102 in each group. As shown, the arrangement also includes series connections, such as series connections 210-1 and 210-2, to connects the six groups of 6 parallel cells 102 in series. Also shown are connection of one of the positive criss-cross connection 208 on the top side of the battery 200 to a main positive terminal 212 of the battery 200, and similarly one of the negative criss-cross connection 208 to a main negative terminal 214 of the battery 200. This completes 6 series-6 parallel (also referred to as 6s-6p) configuration of the 26 cells in the battery 200.

The series connections 210 can be located to result in flow of current through the criss-cross connections 208 such that magnetic effect of the current through all the criss-cross connections 208 is minimized.

As can be appreciated, the criss-cross connections 208 can be provided in same manner as the criss-cross connections 108, i.e., by using one or more conductors, such as nickel straps. Similar criss-cross connections 208 can be provided at lowerside of the battery 200 to complete the parallel configuration of the cells 102 in the sets of three adjacent columns. However, other types of connections, such shorting of all the terminals, as one shown in FIG. 1B, are also within the scope of the present disclosure.

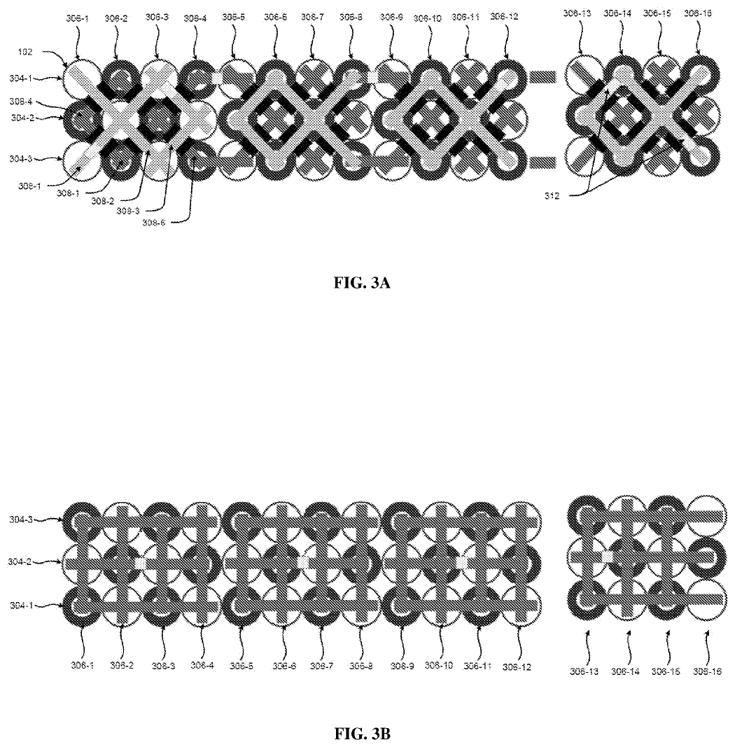

FIGS. 3A and 3B show a third embodiment of the present disclosure wherein. 12 cells 102 are arranged in three rows, such as rows 304-1, 304-2, . . . etc. (hereinafter collectively referred to as row(s) 304) and sixteen columns such as columns 306-1, 306-2, . . . etc. (hereinafter collectively referred to as columns(s) 306). The columns are divided in groups of four adjacently located columns, thereby the sixteen columns 306 forming four groups of adjacently located columns. Also shown are criss-cross connections 308, and series connections 310. The arrangement results in eight series and six parallel configuration of the battery pack.

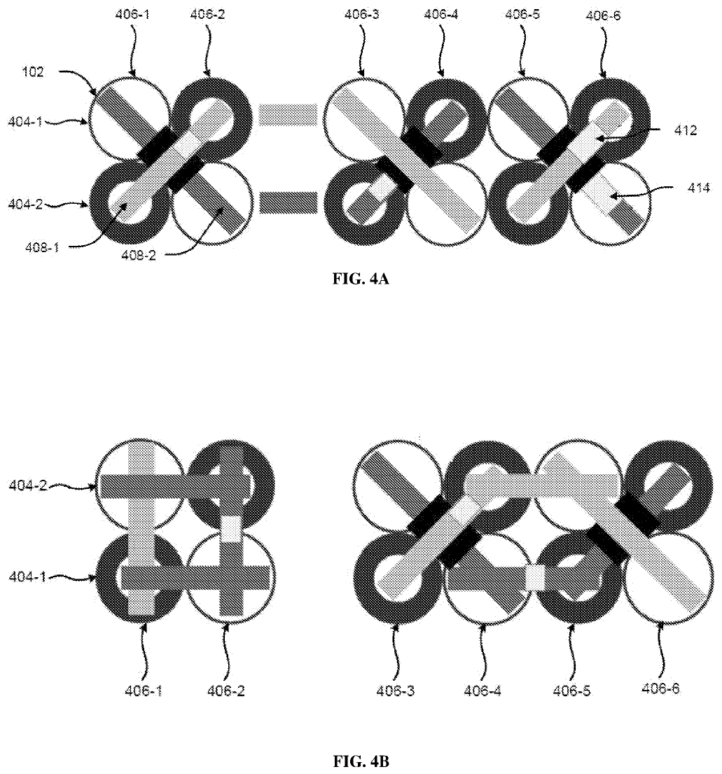

FIGS. 4A and 4B show a fourth second embodiment of the present disclosure, wherein 12 cells 102 are arranged in two rows, such as rows 404-1, 404-2, . . . etc. (hereinafter collectively referred to as row(s) 404) and six columns, such as columns 406-1, 406-2, . . . etc. (hereinafter collectively referred to as columns(s) 406). The columns 406 are divided in groups of two adjacently located columns, thereby the six columns 406 forming three groups of adjacently located columns. Also shown are criss-cross connections 408, and series connections 410. The arrangement results in eight series and six parallel configuration.

Thus, the present disclosure provides a battery pack having a plurality of cells arranged in rows and columns such that magnetic field due to internal current of the cells is minimized. The disclosure also provides for connecting the cells in in parallel and series to get 6s-4p or 6s-6p configuration of the battery.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure overcome drawbacks of the conventional batteries.

The present disclosure provides a battery that has reduced magnetic field due to current in the cells.

The present disclosure provides a battery with reduced magnetic field that is of reduced size when compared to a conventional battery of the corresponding capacity.

The present disclosure provides a battery with reduced magnetic field that can be configured for different desired outputs.

The present disclosure provides a battery pack with increased energy density (Wh/kg), thereby a higher endurance.

We claim:

1. A battery pack comprising a plurality of cylindrical cells, wherein the cells are arranged in parallel disposition such that positive and negative terminals of any of the cells and the closest surrounding cells are oppositely placed which results in magnetic field generated due to internal current of the cells to be minimized by opposite magnetic field generated due to internal current of the oppositely placed surrounding cells.

2. The battery pack as claimed in claim 1, wherein the plurality of cells are arranged in a plurality of parallelly arranged rows and columns, and wherein adjacent cells in each of the rows and the columns are having respective positive and negative terminals in opposite directions, and wherein the plurality of rows and columns are arranged such that the closest surrounding cells of any of the cells are oppositely placed cells.

3. The battery pack as claimed in claim 2, wherein each of the positive terminals and the negative terminals at any of or both of upper ends and lower ends of the cells in a group of adjacently located columns, each group of adjacently located columns comprising two or more columns, are connected in a criss-cross manner by one or more conductors, wherein the mutually connected positive terminals and the negative terminals at any or both ends of the cells in the group of adjacently located columns provide a parallel electric connection of the cells thereby providing two sets of parallelly connected cells in the group of adjacently located columns.

4. The battery pack as claimed in claim 3, wherein the mutually connected positive terminals at the upper end of the cells of one of the groups of adjacently located columns are connected to a main positive terminal of the battery pack, and the mutually connected negative terminals at the upper end of the cells of one of the groups of adjacently located columns are connected to a main negative terminal of the battery pack.

5. The battery pack as claimed in claim 4, wherein the remaining mutually connected positive terminals and the mutually connected negative terminals at any or both of the upper ends and the lower ends of the cells of the groups of adjacently located columns are connected to the mutually connected terminals of opposite polarity at the respective ends of the cells of the adjacent group of adjacently located columns to provide a series connection of the sets of parallelly connected cells of the different groups of adjacently located columns.

6. The battery pack as claimed in claim 5, wherein of the positive terminals and the negative terminals only at the upper end of the cells in a group of adjacently located columns are connected in a criss-cross manner by one or more conductors, and the positive terminals and the negative terminals at the lower ends of all the cells are connected to each other by shorting to provide a parallel connection of the cells in the sets of cells of the different groups of adjacently located columns, as well as series connection of the sets of parallelly connected cells.

7. The battery pack as claimed in claim 5, wherein the connection between the criss-cross connections of the different groups of adjacently located columns are configured to cause flow of current through the criss-cross connections such that magnetic effect of the current through all the criss-cross connections is minimized.

8. The battery pack as claimed in claim 6, wherein the battery pack comprises 24 cells arranged in four rows and six columns, and further the groups of adjacently located columns comprise two columns, thereby the six columns forming three groups of adjacently located columns, and wherein the battery pack comprises a six series and four parallel configuration.

9. The battery pack as claimed in claim 6, wherein the battery pack comprises 12 cells arranged in two rows and six columns, and further the groups of adjacently located columns comprise two columns, thereby the six columns forming three groups of adjacently located columns, and wherein the battery pack comprises a six series and two parallel configuration.

10. The battery pack as claimed in claim 6, wherein the battery pack comprises 36 cells arranged in four rows and nine columns, and further the groups of adjacently located columns comprise three adjacent columns, thereby the nine columns forming three groups of three adjacent columns, and wherein the battery pack comprises a six series and six parallel configuration.

11. The battery pack as claimed in claim 6, wherein the battery pack comprises 48 cells arranged in three rows and sixteen columns, and further the groups of adjacently located columns comprise four adjacent columns, thereby the sixteen columns forming four groups of four adjacent columns, and wherein the battery pack comprises a eight series and six parallel configuration.

12. The battery pack as claimed in claim 1, wherein the cells are li-ion cells.

13. The battery pack as claimed in claim 1, wherein the battery pack is used for an un-manned Aerial Vehicle.
